(19) United States
(12) Patent Application Publication
(10) Pub. No.: US 2025/0102007 A1
(43) Pub. Date: Mar. 27, 2025

(54) CLAMP FOR SECURING ROOF-MOUNTED EQUIPMENT TO A ROOF-MOUNTED PEDESTAL

(71) Applicant: Timothy M. Graboski Revocable Trust, Deerfield Beach, FL (US)

(72) Inventor: Timothy Michael Graboski, Deerfield Beach, FL (US)

(21) Appl. No.: 18/891,971

(22) Filed: Sep. 20, 2024

Related U.S. Application Data
(60) Provisional application No. 63/584,757, filed on Sep. 22, 2023.

(51) Int. Cl. F16B 21/20; H02S 20/23

(52) U.S. Cl. CPC F16B 21/20; H02S 20/23

(57) ABSTRACT

Embodiments of a clamp (20) of this disclosure are adapted for securing a piece of equipment to a roof-mounted pedestal or rail (10) that has a slot (12) running along its top end (14). The clamp includes an upper body (300), a lower body (200) partially surrounded by the upper body, a holding spring (330) contained by the upper body, and a mounting bolt (100) that passes through the holding spring and is received by a rail nut (220) of the lower body. The lower body includes a pair of legs (211) with winged- or scroll-shaped feet (212) adapted for capture by the slot of the pedestal or rail. As the mounting bolt is tightened, a flange (324) of the upper body is drawn downward against an opposing surface of the equipment and the winged feet of the lower body are drawn upward against an opposing surface of the slot.

### CROSS-REFERENCE TO CO-PENDING APPLICATIONS

This application claims priority to U.S. 63/584,757 filed Sep. 22, 2023.

### BACKGROUND

This disclosure relates generally to equipment clamps and systems for securing roof-mounted products such as, but not limited to, solar panels and HVAC equipment. More specifically, the disclosure addresses clamps for securing roof-mounted products to pedestals and rail systems that provide T-slots. Embodiments of this disclosure include clamps that are well-suited to mounting equipment of various sizes without damaging the equipment and while meeting or exceeding building codes.

Some roof-mounted products are secured using clamps that attach directly to a roof. These systems require the user to precisely locate the clamps before installing the desired equipment. Other roof-mounted systems use extruded metal railings or pedestals with slots. The SOLAR STACK® panel mount is an example of this type of pedestal. The pedestal allows for adaptability and easier corrections than affixing clamps directly to a roof, however the prior art clamps have a fixed range or a very limited range of panel heights that each can accommodate. Additionally, most clamps currently used to mount equipment to T-slots depend solely on mounting bolts to resist vertical and lateral movement of the equipment. This makes the clamps prone to fail when used for long periods of time or in high-wind conditions. What is needed is a more robust clamp that accommodates a wider range of clamping heights and makes better use of holding springs to secure roof-mounted equipment to the pedestals or rails.

### SUMMARY

Embodiments of a clamp of this disclosure are intended for use in securing a piece of equipment to a roof-mounted pedestal or rail, the roof mounted pedestal or rail having a slot running along its top or topmost end. The slot may be a T-slot. The clamp includes an upper body, a lower body partially surrounded by the upper body, a holding spring contained by the upper body, and a mounting bolt that passes through the holding spring. The lower body includes a pair of legs with feet that are contained within, and captured, by the slot of the pedestal or rail. As the mounting bolt is tightened, a flange of the upper body is drawn downward against an opposing surface of the equipment and the winged feet of the lower body are drawn upward against an opposing surface of the slot, thereby clamping the piece of equipment to the pedestal or rail.

In embodiments, the upper body includes an upper plate, a lower plate, and two vertical sidewalls extending between the upper and lower plate. The upper plate extends laterally beyond at least one of the vertical sidewalls to provide a flange and the upper plate further includes a centrally located mounting bolt hole. The lower plate includes a centrally located opening sized to receive the lower body. The upper body further including a through channel that houses the holding spring and into which a portion of the lower body enters.

The lower body is partially contained within the centrally located opening of the lower plate of the upper body, and is displaceable relative to the upper body, that is, moving upward or downward relative to the upper body. In embodiments, the lower body includes a rail nut at its upper end and a pair of legs extending vertically below the lower plate of the upper body. A portion of the upper end of the lower body is shaped complementary to the centrally located opening of the lower plate. Each of the legs extends below the lower plate in a vertical direction and ends in a winged foot containing an outward-facing horizontal groove.

The holding spring is housed within the channel of the upper body. A mounting bolt is received by the mounting hole of the upper plate and the rail nut of the lower body, the holding spring surrounding a portion of the mounting bolt.

In an intended use, the winged feet of the legs are received in the slot of the mounting pedestal or and the laterally extending flanges of the upper plate overlaps corresponding surfaces of adjacent pieces of roof-mounted equipment, such as but limited to solar panels, which are resting on the mounting pedestal. As the mounting bolt is tightened, the lower body is drawn upwards and the clamp secures the equipment to the pedestal. The adjustability of the lower body to that of the upper body permits a range of solar panel thicknesses to be secured by the clamp.

### BRIEF DESCRIPTION OF THE DRAWINGS

FIG. 1 is an embodiment of a clamp of this disclosure in use with a prior art roof-mounted pedestal and arranged to receive solar panels.

FIG. 2 is a an embodiment of a clamp of this disclosure when inserted into a slot located along a top surface of the prior art pedestal of FIG. 1.

FIG. 3 is a schematic front elevation view of the clamp of FIG. 2 in an assembled state and clamping down a roof-mounted product to its mounting pedestal. The lower body of the clamp may arranged relative to the upper body so the winged feet of the clamp orient in a same direction, or perpendicular to, the flanges of the upper body of the clamp.

FIG. 4 is an embodiment of the clamp when connected to the pedestal. Here the lower body is arranged so that the winged feet are oriented perpendicular to the flanges of the upper body.

FIG. 5 is a front elevation view of the clamp of FIG. 4.

FIG. 6 is a a side elevation view of the clamp of FIG. 4.

FIG. 7 is an isometric view of an alternate embodiment of the clamp, the upper body of the clamp including a recessed upper plate rather than being a flat upper plate.

FIG. 8 is an isometric view of the clamp of FIG. 7 located between two solar panels and clamping each to the roof-mounted pedestal.

FIG. 9A is an isometric view of an embodiment of the clamp of FIG. 3.

FIG. 9B is another isometric view of the clamp of FIG. 3.

FIG. 10 is an isometric bottom view of the clamp.

FIG. 11 is a front elevation view of an embodiment of the lower body of a clamp of this disclosure.

FIG. 11A is a detailed view of section A of FIG. 11.

FIG. 12 is a side elevation view of the lower body of FIG. 11.

FIG. 13 is a front elevation view of an embodiment of an upper body of a clamp of this disclosure.

FIG. 14 is a top view of the upper body of FIG. 13.

FIG. 15 is a schematic illustrating the lower body when inserted into a slot of the pedestal and engaging the flanges of the slot.

FIG. 16 is a cross-section view of an embodiment of the clamp in an assembled state.

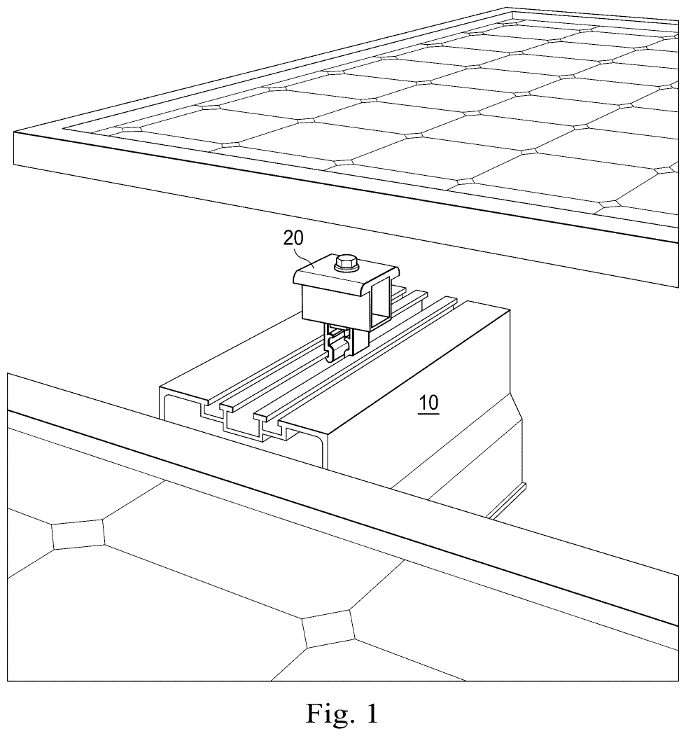

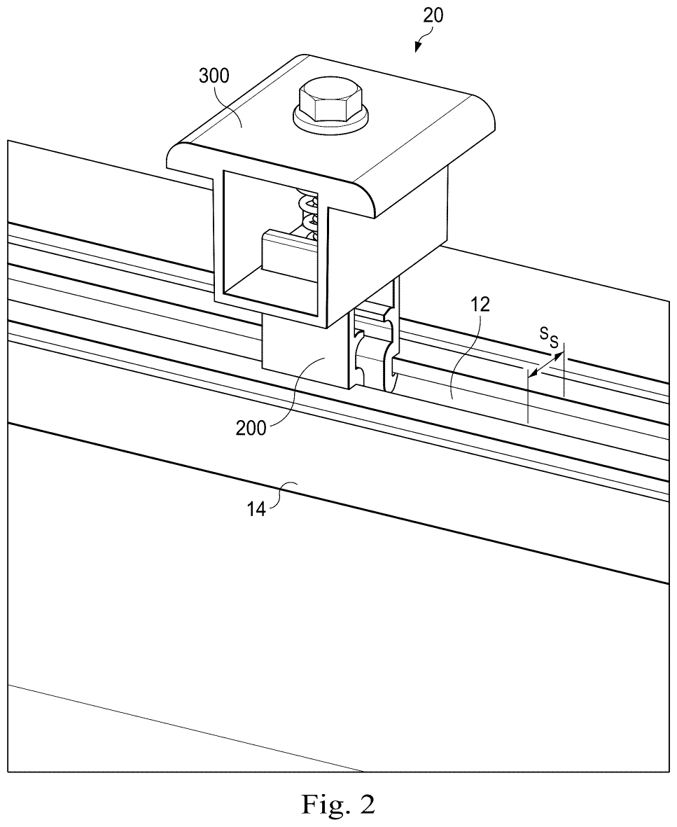

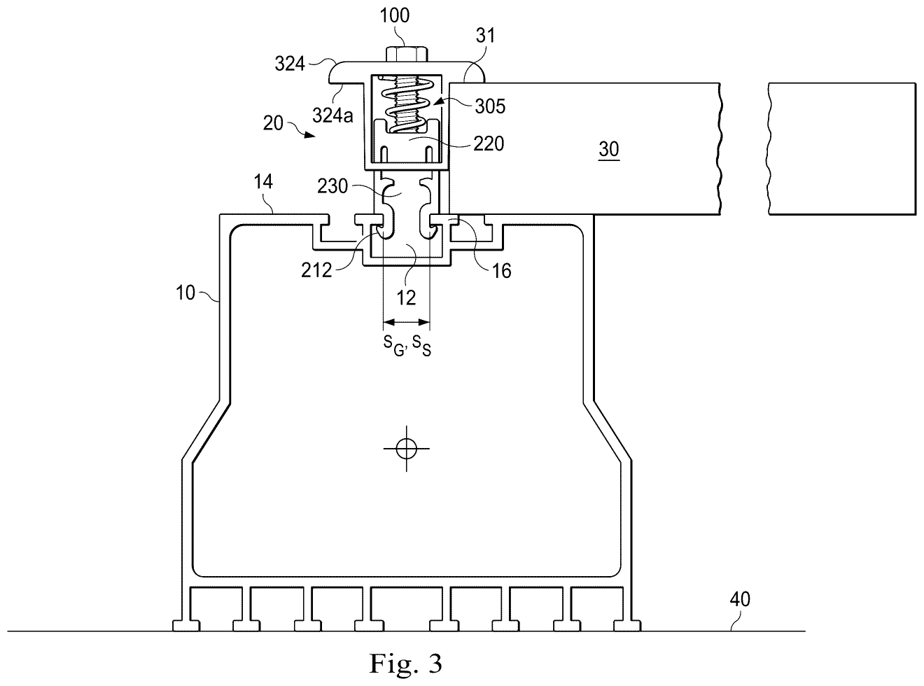

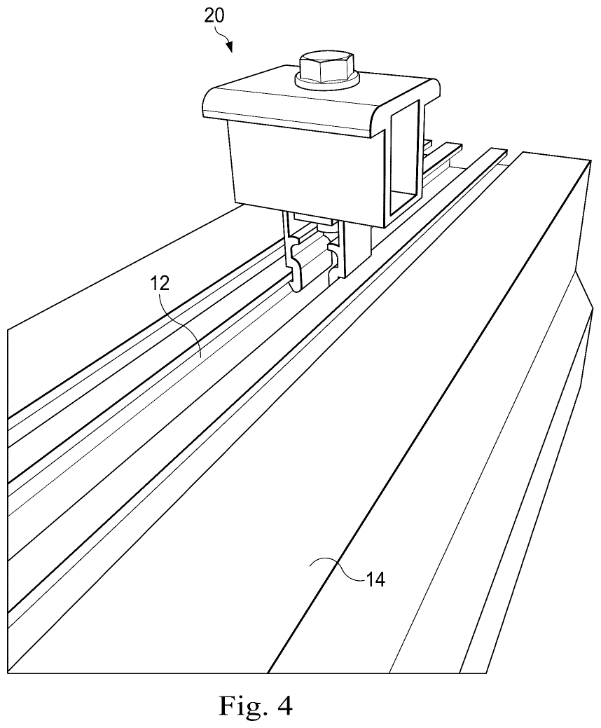

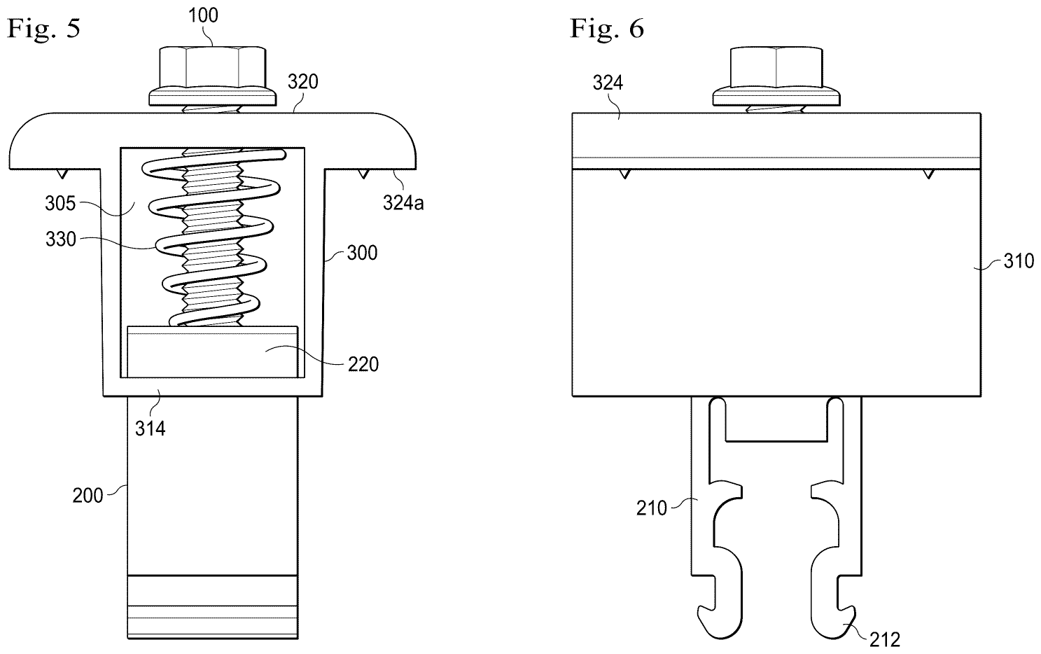

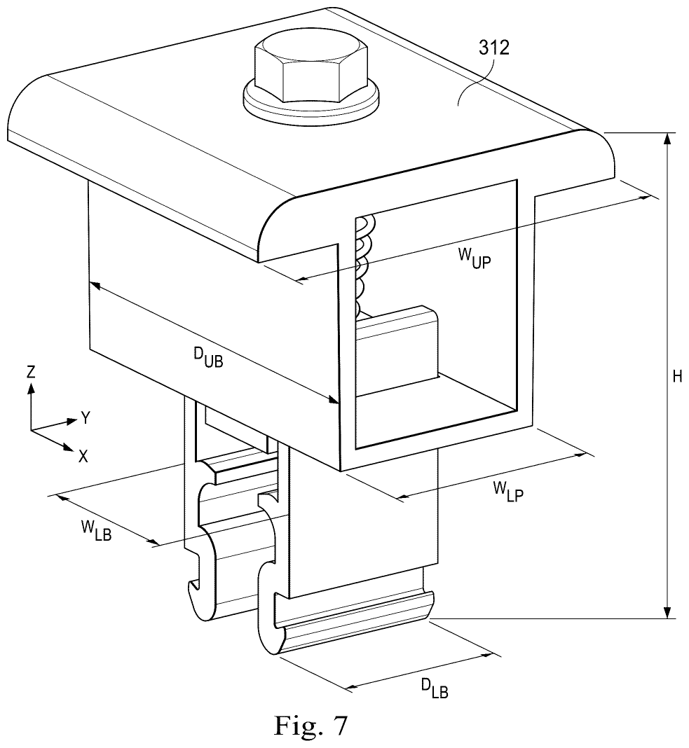

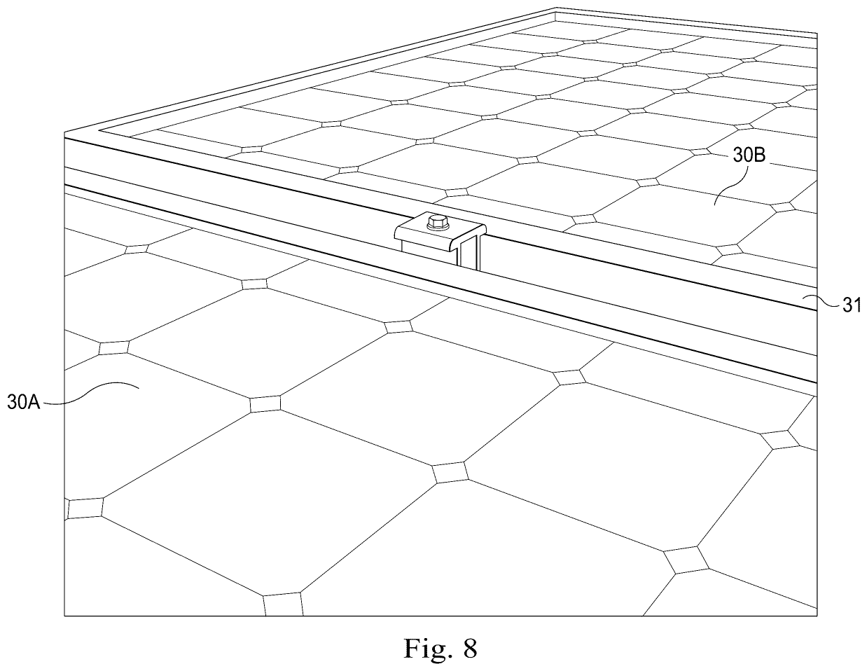

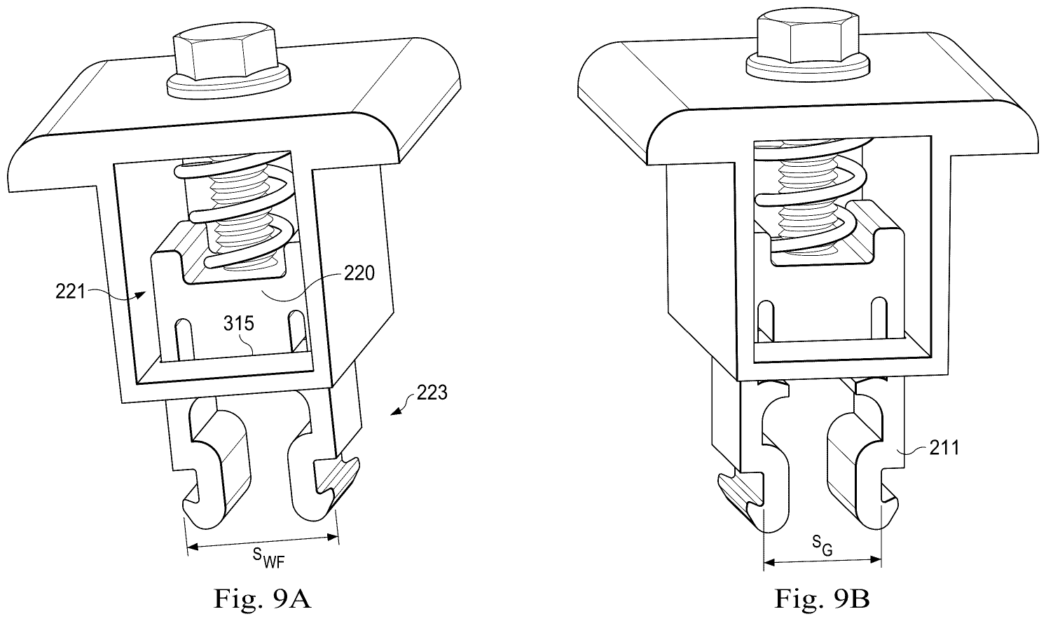

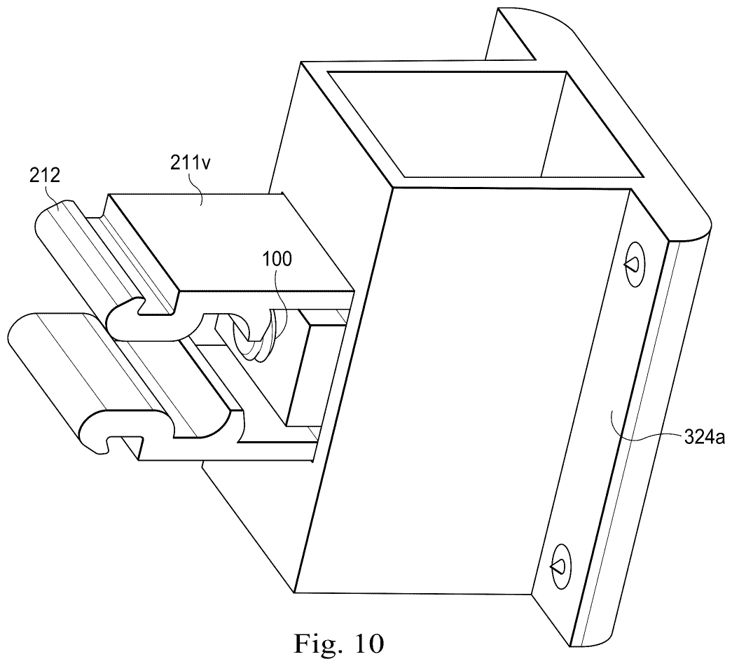

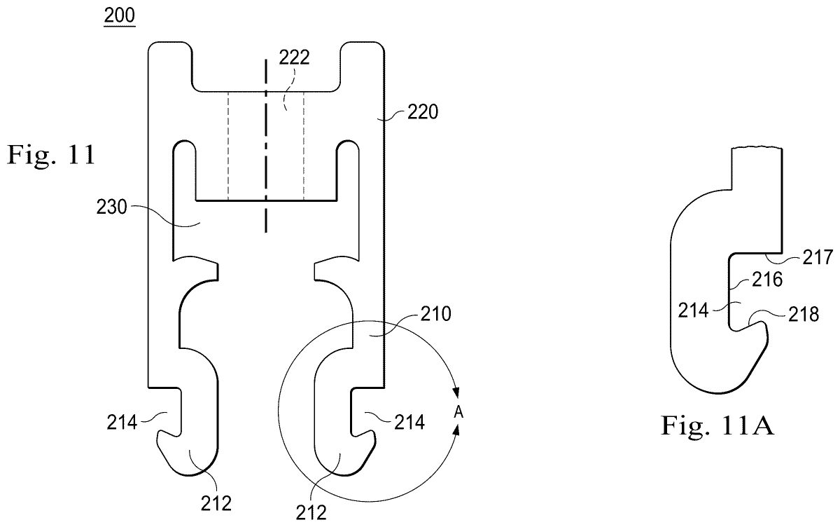

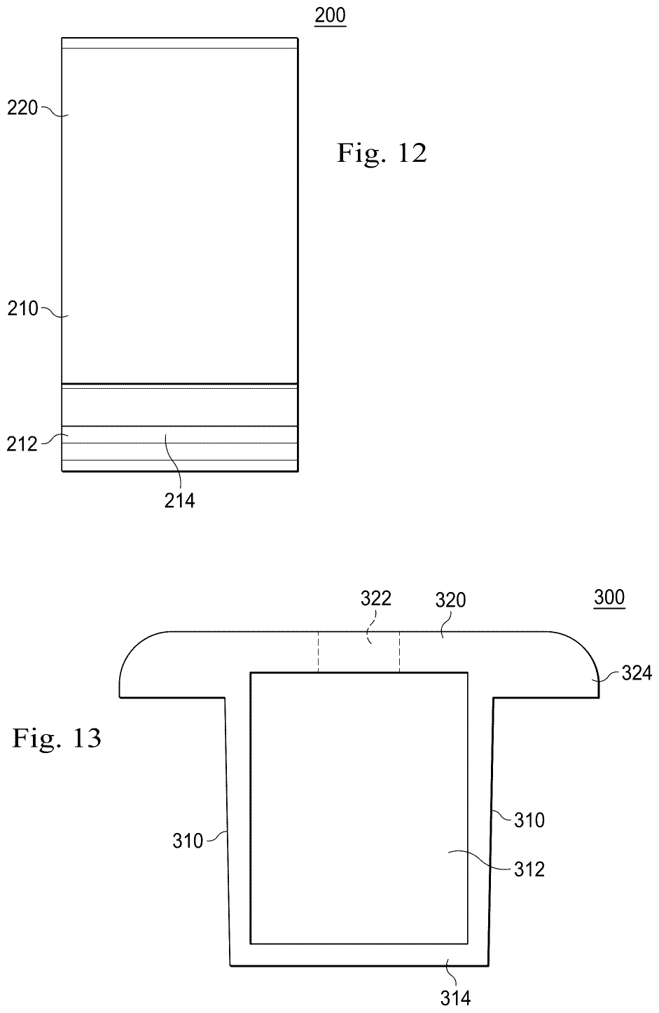

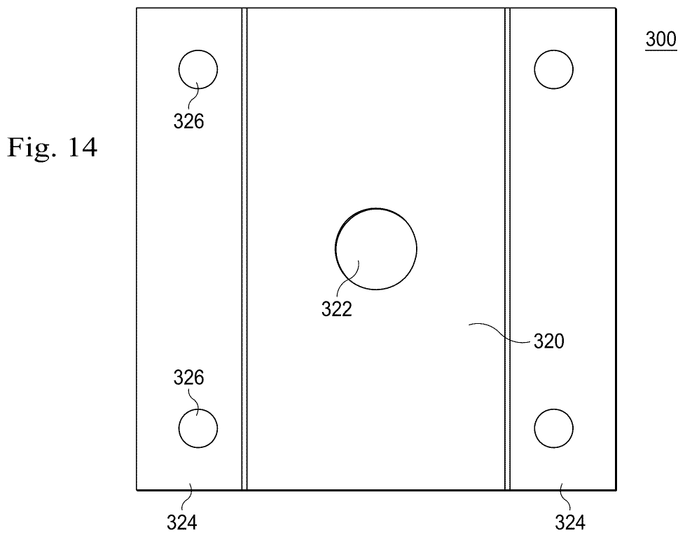

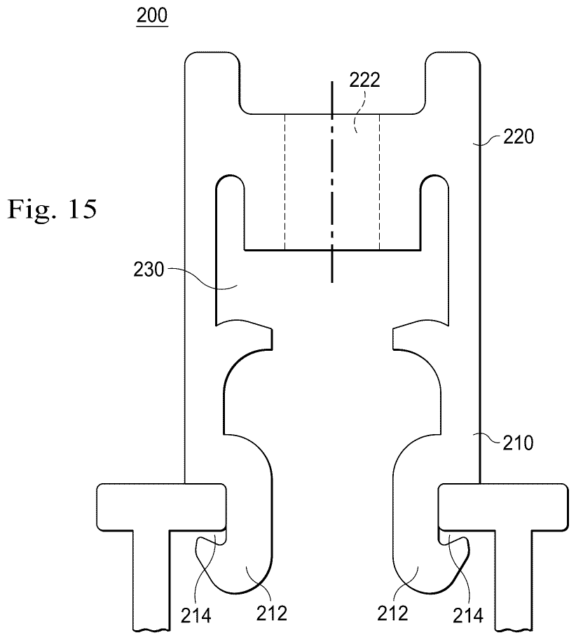

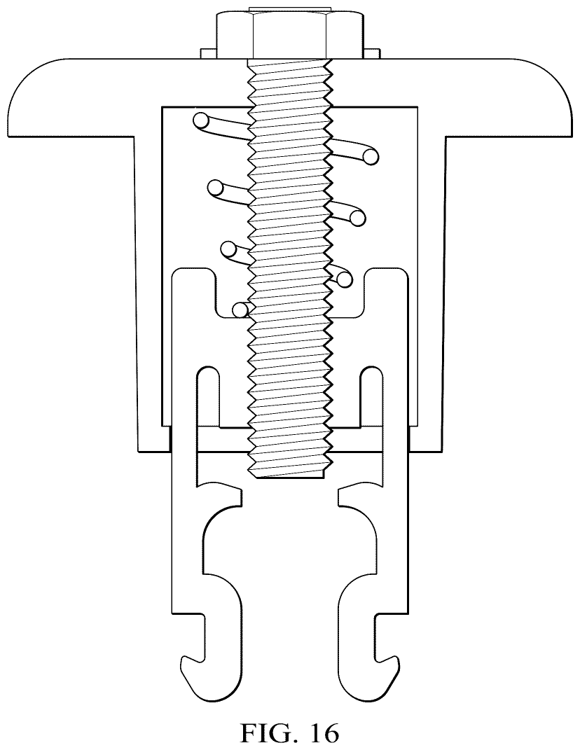

### DESCRIPTION

Embodiments of a system of this disclosure comprise an equipment clamp 20 for securing roof-mounted products 30 to a roof-mounted rail or pedestal 10 having a slot 12 along its top or topmost end 14. When in an intended use, the clamp 20 engages an edge portion 31 of the roof-mounted product 30 resting on the pedestal 10 and secures the product 30 to the pedestal 10. In some applications, the clamp 20 may reside between two roof-mounted products 30A, 30B and engage a corresponding edge portion 31 of each. The roof-mounted products 30A, 30B may be solar panels.

The clamp 20 is a two-piece clamp comprising an upper body 300; a lower body 200 at least partially contained by, and removable from, the upper body 300; a holding spring 330 housed by the upper body 300; and a mounting bolt 100 passing through the holding spring 330 and into a rail nut 220 of the lower body 200. The upper body 300 includes at least one flange 324 adapted to clamp onto an opposing portion or edge 31 of the roof-mounted product 30.

When in an intended use, winged feet 212 of the lower body 200 are captured within the slot 12 of the mounting pedestal 10. As the mounting bolt 100 is tightened, the overall height H of the clamp 20 decreases as the lower and upper bodies 200, 300 are drawn toward one another, thereby moving the clamp 20 from an unclamped state into a clamped state. In embodiments, the clamp 20 may be sized to accommodate a predetermined range of roof-mounted equipment heights. In some embodiments, the clamp 20 is intended for use with solar panels and has a working height H in a predetermined range, making it suitable for a desired range of panel heights. In embodiments, the range may be 25 to 51 mm, there being sub-ranges and discrete values within this broader range. In some embodiments, the clamp 20 accommodates solar panels in a range of 30 to 46 mm. One clamp 20 may work as a mid and an end clamp. The clamp 20 should meet UL 2703 certification requirements.

In embodiments, the upper body 300 of clamp 20 includes an upper and a lower plate 320, 314 spaced apart from one another by a two opposing vertical sidewalls 310. The plates 320, 314 and the sidewalls 310 form an open channel 305 through the upper body 300. Contained within the open channel 305 is the holding spring 330 through which the mounting bolt 100 passes. The holding spring 330 may be a compression spring, especially a tapered or canonical spring to make efficient use of space within open channel 300, maximize the opening range or capacity of the equipment clamp 20, and stabilize the load absorption of the equipment clamp 20. Other sorts of compression springs may be used as the holding spring 330 as well.

The upper plate 320, which may be flat across or include a recess 312, includes a centrally located upper bolt hole 322 and defines at least one flange 324. The flange 324 extends in a lateral direction beyond a corresponding one of the vertical sidewalls 310 to provide a clamping surface 324A, making the width W_{UP} of the upper plate 320 greater than the width W_{LP} of the lower plate 314. The angle between the flange 324 and vertical side wall 310 may be 90 degrees. The lower plate 314 includes a central opening 315 sized to receive the lower body 200 and shaped complementarily to the lower body 200 to limit or prevent rotation of the lower body 200 relative to the upper body 300.

The lower body 200 has a rail nut 220 at its upper end 221 and a pair of legs 211 at its lower end 223. The pair of legs 211 extend away from the upper end 221 in a longitudinal direction and end in a pair of winged feet 212. The legs 211 are spaced apart from one another to form a channel 230, the channel-facing walls 211c being non-linear along their length. In some embodiments, the channel 230 is key-hole shaped. An upper portion 213 of the legs 211 forms outward-facing vertical sidewalls 211v that are received by the opening 315 of the lower plate 314. The walls 211v define a width W_{LB} and depth D_{LB} of the lower body 200. In embodiments W_{LB} may be less than the depth D_{UB} of the upper body and D_{LB} may be less than the width of the lower plate W_{LP}.

When the clamp 20 is in an assembled state, the lower body 200 is contained at least partially within the opening 315, with the rail nut 220 residing between the upper and lower plates 320, 314 and the feet 212 residing below the lower plate 314.

In some embodiments the opening 315 and a perimeter of the upper end 221 of the lower body 200 are square-shaped, thereby permitting two different orientations of the lower body 200 relative to the upper body 300. In one orientation of the lower body 200, the channel 230, formed by the legs 211 of the lower body 200, opens in a same direction as that of the channel 305 (e.g. X direction or Y direction). In another orientation of the lower body 200, the channels 230, 305 are in directions orthogonal to one another (e.g. one in the X direction, the other in the Y direction). In embodiments, channels 230 and 305 have different shapes from one another.

The winged feet 223 are adapted to fit into, an capture a lip or flange 16 of, a slot 12 in a mounting pedestal 10. (see FIG. 10), thereby preventing escape from the slot 12 as the as the mounting bolt 100 of the clamp 20 is tightened and clamping force is exerted by the clamp 20 onto the piece of roof-mounted equipment 30 resting on the pedestal 10. In embodiments, each winged foot 212 is scroll- or C- or J-shaped with an outward-facing horizontal groove 214 adapted to engage a lip or flange 16 of the slot 12.

In embodiments, the throat or groove 214 of the foot 212 has a predetermined height H and depth D to engage and be retained by slot 12 of the mounting pedestal 10. The spacing SG between the outward facing grooves 214 is no greater than the spacing SF between the opposing flanges 16 or the slot walls The height H and depth D of the horizontal groove 214 is sized to capture the flange 16.

A top end 217 of the groove 214 may be generally perpendicular to the outward-facing sidewall 216 of the groove 214. The bottom end 218 of the groove 214 may form an angle in a range of 60 degrees to less than 90 degrees relative to the outward-facing sidewall 216, there being sub-ranges and discrete values within this broader range. In some embodiments, the angle is in a range of 70 to 75 degrees.

Embodiments of a method of this disclosure includes providing a clamp 20 of this disclosure, inserting the legs 211 of the clamp 20 into a slot 12 located along the top surface 14 of a roof-mounted pedestal 10; positioning the clamp 20 into a desired position along the slot 12, and tightening the mounting bolt 100 to engage an edge portion 31 of the roof-mounted equipment 30 resting on the pedestal 30 and, using the clamp 20, secure the equipment 30 to the pedestal 30. In some embodiments of the method, the upper and lower bodies 300, 200 are connected during the insertion and positioning. In other embodiments, the lower body 300 is inserted first and then the upper body 200 is coupled to it.

What is claimed:

1. A clamp (20) adapted for securing a piece of equipment to a roof-mounted pedestal or rail, the roof mounted pedestal or rail having a slot (12) running along its top end (14), the apparatus comprising:
an upper body (300) including an upper plate (320), a lower plate (314), and two vertical sidewalls (211v) extending between the upper and lower plate, the upper plate extending laterally beyond at least one of the vertical sidewalls to provide a flange (324) and including a centrally located mounting bolt hole (332), the lower plate including a centrally located opening (315), the upper body further including a through channel (300);
a lower body (200) partially contained within the centrally located opening of the lower plate, the lower body including a rail nut (220) at an upper end (221) and a pair of legs (211) extending vertically below the lower plate, a portion of the upper end shaped complementary to the centrally located opening of the lower plate, each of the legs extending below the lower plate in a vertical direction and ending in a winged foot (212) containing an outward-facing horizontal groove (214);
a holding spring (330) housed within the through channel of the upper body; and
a mounting bolt (100) received by the centrally located mounting bolt hole of the upper plate of the upper body and the rail nut of the lower body, the holding spring surrounding a portion of the mounting bolt.
